(19) United States
(12) Patent Application Publication
(10) Pub. No.: US 2010/0092375 A1
(43) Pub. Date: Apr. 15, 2010

(54) AMORPHOUS FINE-PARTICLE POWDER, METHOD FOR PRODUCING THE SAME AND PEROVSKITE-TYPE BARIUM TITANATE POWDER PRODUCED BY USING THE SAME

(75) Inventor: Junya Fukazawa, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NIPPON CHEMICAL INDUSTRIAL CO., LTD., Tokyo (JP)

(21) Appl. No.: 12/527,936

(22) PCT Filed: Feb. 19, 2008
(86) PCT No.: PCT/JP2008/052783

§ 371 Date: Dec. 7, 2009

(30) Foreign Application Priority Data
Feb. 20, 2007 (JP) 2007-040018

(51) Int. Cl. C01G 23/00; C04B 35/46

(52) U.S. Cl. 423/598; 501/135

(57) ABSTRACT

The present invention provides an amorphous fine-particle powder which enables to obtain a fine perovskite-type barium titanate powder free from residual by-products such as barium carbonate and stable in quality, and a method for producing the amorphous fine-particle powder. The amorphous fine-particle powder is a fine-particle powder including titanium, barium, lactic acid and oxalic acid, wherein: the average particle size thereof is 3 μm or less; the BET specific surface area thereof is 6 m²/g or more; the molar ratio (Ba/Ti) of Ba atoms to Ti atoms is 0.98 to 1.02; and the amorphous fine-particle powder is noncrystalline in X-ray diffraction and has a peak of an infrared absorption spectrum in each of a region from 1120 to 1140 cm⁻¹ and a region from 1040 to 1060 cm⁻¹. The method for producing an amorphous fine-particle powder brings a solution (solution A) that contains a titanium component, a barium component and a lactic acid component and a solution (solution B) that contains an oxalic acid component into contact with each other in a solvent that contains an alcohol.

### TECHNICAL FIELD

The present invention particularly relates to an amorphous fine-particle powder including Ba atoms and Ti atoms, useful as a raw material for functional ceramics such as piezoelectrics, optoelectronic materials, dielectrics, semiconductors and sensors, to a method for producing the same, and to a perovskite-type barium titanate powder produced by using the same.

### BACKGROUND ART

Perovskite-type barium titanate has hitherto been used as a raw material for functional ceramics such as piezoelectrics and laminated ceramic capacitors. However, recently, laminated ceramic capacitors are required to be increased in lamination number and to be increased in dielectric constant for the purpose of being increased in capacity. Consequently, perovskite-type barium titanate, which is a raw material for laminated ceramic capacitors, is required to be fine, to have molar ratio of Ba to Ti (hereinafter referred to as “molar ratio Ba/Ti” as the case may be) of approximately 1, and to be high in purity and high in crystallinity.

Barium titanate has hitherto been produced by wet methods such as a solid phase method, a hydrothermal synthesis method, an oxalate method and an alkoxide method. Among these methods, the oxalate method is generally a method in which an aqueous solution of TiCl₄ and BaCl₂ is added dropwise under stirring to an aqueous solution of oxalic acid (H₂C₂O₄) set at about 70° C. to yield barium titanyl oxalate having a molar ratio of Ba to Ti of 1, and then the barium titanyl oxalate is calcined. This oxalate method is characterized in that the composition of the obtained barium titanyl oxalate is uniform, and the targeted substance can be obtained with a stable molar ratio in a satisfactory yield. In most cases, the molar (Ba/Ti) ratio is approximately 1. However, unfortunately, it is difficult to stably obtain fine materials. For the purpose of solving these problems, for example, Patent Document 1 listed below has proposed a method in which a water-soluble barium salt, a water-soluble titanium salt and an aqueous solution of oxalic acid are mixed together at the same time, a gel thus obtained is intensely stirred to be disintegrated in a short time, and thus obtained fine crystals of barium titanyl oxalate (BaTiO(C₂O₄)₂.4H₂O) are calcined at 700 to 900° C.

Additionally, the present applicants have previously proposed a method for producing a perovskite-type barium titanate powder which method produces barium titanate on the basis of an oxalate method, wherein the method includes a third step of calcining barium titanyl oxalate after barium titanyl oxalate having an average particle size of 50 to 300 μm has been subjected to a wet pulverization treatment and barium titanyl oxalate having an average particle size of 0.05 to 1 μm has been thus obtained to be calcined.

Patent Document 1: Japanese Patent Laid-Open No. 61-146710

Patent Document 2: Japanese Patent Laid-Open No. 2004-123431

### DISCLOSURE OF THE INVENTION

### Problems to be Solved by the Invention

In Patent Documents 1 and 2, a step of pulverization treatment of an intermediate is required because a fine barium titanate powder is obtained by calcining after barium titanyl oxalate as the intermediate has been subjected to a pulverization treatment.

An object of the present invention is to provide an amorphous fine-particle powder which enables to obtain a fine perovskite-type barium titanate powder free from residual by-products such as barium carbonate and stable in quality, without conducting such a pulverization treatment before calcination as conventionally conducted, and to provide a method for producing the amorphous fine-particle powder.

Another object of the present invention resides in the provision of a perovskite-type barium titanate powder obtained by using the above-described amorphous fine-particle powder.

### Means for Solving the Problems

The present inventor has continuously conducted a diligent study on the method for producing a perovskite-type barium titanate powder on the basis of an oxalate method, and consequently has discovered that by adding lactic acid to a titanium compound, the hydrolysis reaction and the like of the titanium compound are suppressed, and thus a stable transparent solution in which the titanium compound is dissolved can be prepared.

Additionally, the present inventor has discovered that when the transparent solution that contains a titanium component, a barium component and a lactic acid component and a solution that contains an oxalic acid component are brought into contact with each other in a solvent that contains an alcohol, amorphous fine particles are obtained wherein the amorphous fine particles have the molar ratio of Ba atoms to Ti atoms is approximately 1 and have a peak of an infrared absorption spectrum in each of a region from 1120 to 1140 cm⁻¹ and a region from 1040 to 1060 cm⁻¹. The present inventor has perfected the present invention by further discovering that even when the amorphous fine particles are calcined at a low temperature of approximately 800° C., a fine perovskite-type barium titanate powder free from residual by-products such as barium carbonate and stable in quality is obtained.

Specifically, a first aspect to be provided by the present invention is an amorphous fine-particle powder which is a fine-particle powder including titanium, barium, lactic acid and oxalic acid, characterized in that: the average particle size thereof is 3 μm or less; the BET specific surface area thereof is 6 m²/g or more; the molar ratio (Ba/Ti) of Ba atoms to Ti atoms is 0.98 to 1.02; the amorphous fine-particle powder is noncrystalline in an X-ray diffraction method; and the amorphous fine-particle powder has a peak of an infrared absorption spectrum in each of a region from 1120 to 1140 cm⁻¹ and a region from 1040 to 1060 cm⁻¹.

Additionally, a second aspect to be provided by the present invention is a method for producing an amorphous fine-particle powder, characterized in that a solution (solution A) that contains a titanium component, a barium component and a lactic acid component and a solution (solution B) that contains an oxalic acid component are brought into contact with each other in a solvent that contains an alcohol to be reacted with each other.

Yet additionally, a third aspect to be provided by the present invention is a perovskite-type barium titanate powder obtained by calcining the amorphous fine-particle powder according to the first aspect.

### Advantages of the Invention

According to the present invention, an amorphous fine-particle powder which enables to obtain a fine perovskite-type barium titanate powder free from residual by-products such as barium carbonate and stable in quality, without conducting such a pulverization treatment before calcination as conventionally conducted and a method for producing the amorphous fine-particle powder can be provided.

Additionally, the present invention can provide a perovskite-type barium titanate powder obtained by using the above-described amorphous fine-particle powder.

### BEST MODE FOR CARRYING OUT THE INVENTION

Hereinafter, the present invention is described on the basis of preferred embodiments. The amorphous fine-particle powder of the present invention is a fine-particle powder including titanium, barium, lactic acid and oxalic acid, specifically an amorphous fine-particle powder produced by bringing a solution that contains a titanium component, a barium component and a lactic acid component and a solution that contains an oxalic acid component into contact with each other to be reacted with each other, and is noncrystalline in an X-ray diffraction analysis method.

Additionally, the amorphous fine-particle powder has an average particle size, as determined with a scanning electron microscope (SEM), of 0.3 μm or less, preferably 0.1 μm or less and particularly preferably 0.0001 to 0.1 μm.

Additionally, the amorphous fine-particle powder has a BET specific surface area of 6 m²/g or more, preferably 10 m²/g or more and 200 m²/g or less and particularly preferably 20 m²/g or more and 200 m²/g or less, and is also, as a feature thereof, a finer particle powder as compared to usual barium titanyl oxalate powders.

Additionally, the amorphous fine-particle powder includes Ba atoms and Ti atoms, and also has, as a feature thereof, a molar ratio (Ba/Ti) of Ba atoms to Ti atoms of 0.98 to 1.02 and preferably 0.99 to 1.00, and can be suitably utilized, like a barium titanyl oxalate powder, as a raw material for production of a perovskite-type barium titanate powder.

Additionally, the amorphous fine-particle powder has, as a feature thereof, a peak of an infrared absorption spectrum in each of a region from 1120 to 1140 cm⁻¹ and a region from 1040 to 1060 cm⁻¹ due to the lactic acid source in the raw material, and contains lactate radical in the chemical structure thereof. Although the chemical composition of the amorphous fine-particle powder is not clear, the amorphous fine-particle powder is probably a composite organic acid salt that contains Ba and Ti in which salt Ba and Ti are contained in the above-described ranges, and further oxalate radical and lactate radical are contained in appropriate mixing proportions. Accordingly, the amorphous fine-particle powder has an advantage such that a perovskite-type barium titanate powder can be easily produced from the amorphous fine-particle powder by conducting, as described below, an organic acid elimination treatment through calcining the amorphous fine-particle powder.

Further, for the purpose of ensuring the reliability of dielectrics such as laminated capacitors, it is particularly desirable that the amorphous fine-particle powder of the present invention has the above-described properties, and additionally, substantially does not contain chlorine in such a way that the chlorine content is 70 ppm or less and preferably 20 ppm or less.

Additionally, it is possible to include a subcomponent element in the amorphous fine-particle powder of the present invention for the purpose of adjusting the dielectric properties and the temperature properties of the below-described perovskite-type barium titanate powder.

Examples of the usable subcomponent element include at least one element selected from the group consisting of rare earth elements such as Sc, Y, La, Ce, Pr, Nd, Pm, Sm, Eu, Gd, Tb, Dy, Ho, Er, Tm, Yb and Lu; and Li, Bi, Zn, Mn, Al, Ca, Sr, Co, Ni, Cr, Fe, Mg, Zr, Hf, V, Nb, Ta, Mo, W, Sn and Si. The content of the subcomponent element can be optionally set according to the targeted dielectric properties; however, the subcomponent element is preferably contained in the perovskite barium titanate in a content falling within a range from 0.001 to 10% by weight.

Additionally, the amorphous fine-particle powder according to the present invention can be produced by bringing a solution (solution A) that contains a titanium component, a barium component and a lactic acid component and a solution (solution B) that contains an oxalic acid component into contact with each other in a solvent that contains an alcohol to be reacted with each other.

Examples of the usable titanium source to be the titanium component in the solution A include titanium chloride, titanium sulfate, titanium alkoxide or hydrolysates of these compounds. Examples of the usable hydrolysates of the titanium compounds include the products obtained by hydrolyzing aqueous solutions of titanium chloride, titanium sulfate and the like with an alkaline solution of ammonia, sodium hydroxide or the like, and the products obtained by hydrolyzing an aqueous solution of titanium alkoxide with water. Among these, titanium alkoxide is particularly preferably used because titanium alkoxide gives only an alcohol as by-product and enables to avoid contamination of chlorine and other impurities. Specific examples of the titanium alkoxide used include titanium methoxide, titanium ethoxide, titanium propoxide, titanium isopropoxide and titanium butoxide. Among these, titanium butoxide is particularly preferably used because titanium butoxide is industrially easily available, and is provided with various properties including the facts that titanium butoxide itself is satisfactorily stable as a raw material and butanol itself produced by separation is easy to handle. It is to be noted that this titanium alkoxide can also be used as a solution prepared by dissolving the titanium alkoxide in a solvent such as an alcohol.

Examples of the usable barium source to be the barium component in the solution A include barium hydroxide, barium chloride, barium nitrate, barium carbonate, barium acetate, barium lactate and barium alkoxide. Among these, barium hydroxide is particularly preferably used because barium hydroxide is inexpensive, and the reaction can be conducted without being contaminated with chlorine and other impurities.

Examples of the lactic acid source to be the lactic acid component in the solution A include: lactic acid; alkali metal lactates such as sodium lactate and potassium lactate; and ammonium lactate. Among these, lactic acid is particularly preferable because lactic acid does not give any by-product and enables to avoid being contaminated with unnecessary impurities.

Additionally, in the present invention, titanium lactate such as hydroxybis(lactato)titanium to serve as the component source for both of the titanium component and the lactic acid component can also be used.

The solvent for dissolving the titanium component, the barium component and the lactic acid component may be water, or a mixed solvent composed of water and an alcohol.

For the solution A used in the present invention, it is an important prerequisite to prepare a transparent solution in which the titanium component, the barium component and the lactic acid component are dissolved. For that purpose, as the solution A of the present invention, preferable is a solution prepared by conducting a first step of preparing the transparent solution that contains the titanium component, the lactic acid component and water and by successively conducting a second step of adding the barium component to the solution, because the solution thus prepared is obtained as a solution particularly stable in quality.

The operation in the first step may be such that the titanium source is added to an aqueous solution in which the lactic acid source has been dissolved, the lactic acid source is added to a suspension that contains the titanium source and water, or in the case where the titanium compound is in a liquid form, the lactic acid source is added to the titanium compound as it is and then water is added to prepare an aqueous solution.

The addition amount of the lactic acid source in the solution A is set at 2 to 10 and preferably at 4 to 8 in terms of the molar ratio (lactic acid/Ti) to the Ti in the Ti component. This is because when the molar ratio of lactic acid to Ti is less than 2, the hydrolysis reaction of the titanium compound tends to occur, or it comes to be difficult to obtain a stable aqueous solution in which the titanium component is dissolved, and on the other hand, even when the molar ratio exceeds 10, the effect of the lactic acid is saturated and hence no further industrial advantage is obtained. The temperature at which the lactic acid source is added is not particularly limited as long as the temperature concerned is equal to or higher than the freezing point of the solvent used.

The mixing amount of water in the first step is not particularly limited as long as the mixing amount is such that a transparent solution in which the individual components are dissolved is obtained; however, usually it is preferable to adjust the mixing amount of water in such a way that the content in terms of Ti is 0.05 to 1.7 mol/L and preferably 0.1 to 0.7 mol/L, and the content in terms of lactic acid is 0.1 to 17 mol/L and preferably 0.4 to 2.8 mol/L.

Next, to the transparent solution obtained in the first step which solution contains the titanium source, the lactic acid source and water, the above-described barium source is added in the second step.

In consideration of the reaction efficiency, the addition amount of the barium source in the solution A is set, in terms of the molar ratio (Ba/Ti) of Ba to Ti in the titanium component, at 0.93 to 1.02 and preferably at 0.95 to 1.00. This is because when the molar ratio of Ba to Ti is less than 0.93, the reaction efficiency is degraded and hence the (Ba/Ti) of the obtained amorphous fine-particle powder tends to be 0.98 or less, and on the other hand, when the molar ratio concerned exceeds 1.02, the (Ba/Ti) of the obtained amorphous fine-particle powder tends to be 1.02 or more. The temperature at which the barium source is added is not particularly limited as long as the temperature concerned is equal to or higher than the freezing point of the solvent used.

The solution A may be subjected, where necessary, to a concentration adjustment with water and/or an alcohol. In this case, examples of the usable alcohol include one or two or more of methanol, ethanol, propanol, isopropanol and butanol.

In the present invention, the concentrations of the individual components in the solution A are such that: for the titanium component, 0.05 to 1.7 mol/L and preferably 0.1 to 0.7 mol/L in terms of Ti; for the barium component, 0.0465 to 1.734 mol/L and preferably 0.095 to 0.7 mol/L in terms of Ba; and for the lactic acid component, 0.1 to 17 mol/L and preferably 0.4 to 5.6 mol/L in terms of lactic acid.

Additionally, in the present invention, it is possible to further include a subcomponent element, where necessary, in the solution A for the purpose of adjusting the dielectric properties and the temperature properties of the below-described perovskite-type barium titanate powder. Examples of the usable subcomponent element include at least one element selected from the group consisting of rare earth elements such as Sc, Y, La, Ce, Pr, Nd, Pm, Sm, Eu, Gd, Tb, Dy, Ho, Er, Tm, Yb and Lu; and Li, Bi, Zn, Mn, Al, Ca, Sr, Co, Ni, Cr, Fe, Mg, Zr, Hf, V, Nb, Ta, Mo, W, Sn and Si. The subcomponent element compounds are preferably added as acetate, carbonate, nitrate lactate or alkoxide. The addition amount of the subcomponent element-containing compound can be optionally set according to the targeted dielectric properties; however, the addition amount of the subcomponent element-containing compound is, for example, 0.001 to 10% by weight in relation to the perovskite-type barium titanate powder in terms of the element in the subcomponent element-containing compound.

On the other hand, the solution B is a solution that contains oxalic acid, and it is particularly preferable to adopt as the solution B a solution in which oxalic acid is dissolved with an alcohol because such a solution enables to obtain an amorphous fine-particle powder having a high BET specific surface area.

Examples of the usable alcohol include one or two or more of methanol, ethanol, propanol, isopropanol and butanol.

In the solution B, the oxalic acid concentration is usually 0.04 to 5.1 mol/L and preferably 0.1 to 2.1 mol/L, because with such a concentration, the targeted amorphous fine-particle powder is obtained in a high yield.

As the method for bringing the solution A and the solution B into contact with each other in a solvent that contains an alcohol, preferable is a method in which the solution A is added to the solution B under stirring or a method in which the solution A and the solution B are added at the same time to an alcohol-containing solution (solution C) under stirring.

Of these two methods, the method in which the solution A and the solution B are added at the same time to an alcohol-containing solution (solution C) under stirring is preferably used because this method produces a powder having a uniform chemical composition ratio. In this connection, examples of the alcohol usable for the solution C include one or two or more of methanol, ethanol, propanol, isopropanol and butanol; however, it is preferable to use the same alcohol as the alcohol in the solution A and the solution B. In this case, the solvent amount of the alcohol in the solution C is not particularly limited.

The addition amount of the solution A to the solution B or the addition amounts of the solution A and the solution B to the solution C are preferably such that the addition is conducted in such a way that the molar ratio (oxalic acid/Ti) of the oxalic acid in the solution B to the Ti in the solution A is usually 1.3 to 2.3, because such addition enables to obtain the amorphous fine-particle powder in a high yield. Additionally, the stirring speed is not particularly limited as long as the slurry that contains the amorphous fine particles being produced from the start of the addition to the completion of the reaction is always in a state exhibiting fluidity.

In the present invention, the temperature for the mutual contact of the solution A and the solution B is not particularly limited as long as the temperature for the mutual contact is equal to or lower than the boiling point of the solvent used and equal to or higher than the freezing point of the solvent used. Additionally, the addition conducted continuously at a constant rate is preferable because such addition enables the obtained amorphous fine particles to have a molar ratio Ba/Ti of approximately 1 and small in variation so as to have a stable quality and enables to efficiently obtain the amorphous fine particles falling within the above-described range.

After completion of the mutual contact of the solution A and the solution B, an aging reaction is conducted where necessary. Performing of the aging reaction perfects the reaction of the produced amorphous fine particles, and hence enables to obtain an amorphous fine-particle powder that has a BET specific surface area falling within the above-described range, a molar ratio Ba/Ti of 0.98 to 1.02, preferably 0.99 to 1.00 and a composition small in variation.

In the aging conditions, the aging temperature is not particularly limited but the aging reaction is conducted preferably at a temperature of 10 to 50° C., and the aging time of 3 minutes or more is sufficient. It is to be noted that the aging temperature as referred to herein means the temperature of the whole mixture after completion of the mutual contact of the solution A and the solution B. After completion of the aging, the solid-liquid separation is conducted by a conventional method, the aged amorphous fine particles are washed where necessary, and dried and disintegrated to yield the targeted amorphous fine-particle powder. It is to be noted that in the present invention, the case where titanium alkoxide is used as the titanium source and barium hydroxide is used as the barium source has an advantage that the step of washing the impurities such as chlorine can be omitted.

Preferably, the amorphous fine-particle powder thus obtained has a molar ratio Ba/Ti of 0.98 to 1.02 and preferably 0.99 to 1.00, a BET specific surface area of 6 m²/g or more, preferably 10 m²/g or more and 200 m²/g or less and particularly preferably 20 m²/g or more and 200 m²/g or less, a peak of an infrared absorption spectrum in each of a region from 1120 to 1140 cm⁻¹ and a region from 1040 to 1060 cm⁻¹, and a chlorine content of 70 ppm or less and preferably 20 ppm or less.

Additionally, the amorphous fine-particle powder has an average particle size, as determined with a scanning electron microscope (SEM), of 0.3 μm or less, preferably 0.1 μm or less and particularly preferably 0.0001 to 0.1 μm.

Next, the perovskite-type barium titanate powder of the present invention is described.

The method for producing a perovskite-type barium titanate powder of the present invention is characterized in that the amorphous fine-particle powder is calcined.

The organic matter derived from the oxalic acid or the lactic acid contained in the final product is not desirable because such organic matter impairs the dielectric properties of materials, and additionally function as unstable factors for the behavior in the thermal step for ceramization. Accordingly, in the present invention, the targeted perovskite-type barium titanate powder is obtained by thermally decomposing the amorphous fine-particle powder by calcination, and at the same time, it is necessary to sufficiently remove the organic matter derived from oxalic acid or lactic acid.

The calcination conditions are such that the calcination temperature is 600 to 950° C. and preferably 700 to 850° C. The reasons for setting the calcination temperature in the above-described range are as follows: the calcination temperature lower than 600° C. is not preferable because at such a temperature, the formation reaction, based on thermal decomposition, of the perovskite-type barium titanate powder is not completed; on the other hand, the calcination temperature exceeding 950° C. is not preferable because at such a temperature, particle growth occurs and hence the targeted fine-particle perovskite-type barium titanate powder is not obtained.

The calcination atmosphere is not particularly limited, and may be any of an atmosphere of air, a reduced pressure atmosphere, an atmosphere of oxygen and an atmosphere of an inert gas. Additionally, in the present invention, calcination may be repeated as many times as desired. Alternatively, for the purpose of uniformalizing the powder properties, the powder once calcined may be pulverized and successively calcined again.

After the calcination, the calcined product is appropriately cooled, pulverized where necessary, and thus the perovskite-type barium titanate powder is obtained. The pulverization conducted where necessary is appropriately conducted in a case such as the case where the perovskite-type barium titanate powder obtained by calcination takes a weakly-bonded block-like form; however, the particles themselves of the perovskite-type barium titanate powder have the below-described specific average particle size and BET specific surface area.

Specifically, the obtained perovskite-type barium titanate powder is a powder in which the average particle size, as determined with a scanning electron microscope (SEM), is usually 0.02 to 0.3 μm and preferably 0.05 to 0.15 μm, the BET specific surface area is 6 m²/g or more and preferably 8 to 20 m²/g, and the particle size variation is small. In addition to the above-described physical properties, in the obtained perovskite-type barium titanate powder, the chlorine content is preferably 20 ppm or less and more preferably 10 ppm or less, and the molar ratio of Ba to Ti is 0.98 to 1.02 and preferably 0.99 to 1.00, and the crystallinity is excellent.

For example, in the production of laminated ceramic capacitors, the perovskite-type barium titanate powder according to the present invention is converted into a slurry by being mixed and dispersed in an appropriate solvent together with mixing ingredients such as heretofore known additives, an organic binder, a plasticizer and a dispersant; and by performing sheet formation with the slurry, a ceramic sheet for use in the production of laminated ceramic capacitors can be obtained.

In the production of a laminated ceramic capacitor by using the ceramic sheet, first a conductive paste for use in formation of an internal electrode is printed on one side of the ceramic sheet, and after drying two or more sheets of the ceramic sheet are laminated and bonded to each other by pressing in the thickness direction to form a laminated body. Next, the laminated body is heat treated for a debindering treatment, and fired to yield a fired body. Further, a Ni paste, a Ag paste, a nickel alloy paste, a copper paste, a copper alloy paste or the like is applied to the fired body and baked, and thus a laminated ceramic capacitor can be obtained.

Additionally, for example, the perovskite-type barium titanate powder according to the present invention is mixed in a resin such as epoxy resin, polyester resin or polyimide resin, and thus, a resin sheet, a resin film, an adhesive and the like are produced; and these resin materials can be used as materials for printed wiring boards, multiple-layer printed wiring boards and the like, as a common material to suppress the contraction difference between an internal electrode and a dielectric layer, as an electrode ceramic circuit board, as a glass ceramic circuit board and as a circuit peripheral material.

Additionally, the perovskite-type barium titanate powder obtained in the present invention can be suitably used as catalysts used for removal of exhaust gas and for reactions in chemical synthesis and the like, and as surface modifiers of printing toners imparting antistatic effect and cleaning effect.

### EXAMPLES

Hereinafter, the present invention is described with reference to Examples, but the present invention is not limited to these Examples.

### Example 1

A solution was prepared as the solution B by dissolving at 25° C. 6.67 g of oxalic acid dihydrate in 100 ml of ethanol.

On the other hand, a transparent solution was prepared by adding at 25° C. to 8.56 g of tetra-n-butyl titanate, 18.22 g of lactic acid, and successively 30 g of purified water under stirring little by little. Next, to the transparent solution, 7.75 g of barium hydroxide octahydrate was added and dissolved at 25° C.; thereafter, the solution thus obtained was diluted with ethanol to prepare 100 ml of a solution as the solution A.

Next, the total amount of the solution A and the total amount of the solution B were added dropwise under stirring at the same time at 25° C. to 100 ml of ethanol (solution C) over a period of 15 minutes. After completion of the dropwise addition, aging was conducted at 25° C. for 15 minutes to yield a precipitate.

The precipitate was filtered off and dried at 80° C. to prepare a powder. The electron microscope photograph of the powder was taken, and the molar ratio Ba/Ti, the BET specific surface area, the X-ray diffraction, the FT-IR spectrum and the chlorine content based on ion chromatography were measured. Consequently, the powder was revealed to be noncrystalline (see FIG. 1) in terms of X-ray diffraction and to be the amorphous fine-particle powder shown in Table 1. FIG. 1 is an X-ray diffraction chart of the amorphous fine-particle powder obtained in Example 1, and the curve was recorded along the abscissa.

Further, the infrared (IR) absorption spectrum of the amorphous fine-particle powder is shown in FIG. 2. Additionally, a scanning electron microscope photograph is shown in FIG. 3.

It is to be noted that the molar ratio Ba/Ti was obtained with a fluorescent X-ray method.

The average particle size was determined as an average value over the 200 particles arbitrarily extracted from the electron microscopic observation at a magnification of 70 thousands in each of Examples 1 and 3, as an average value over the 200 particles arbitrarily extracted from the electron microscopic observation at a magnification of 1000 in Comparative Example 1, and as an average value over the 200 particles arbitrarily extracted from the optical microscopic observation at a magnification of 130 in Comparative Example 2.

### Comparative Example 1

A solution was prepared as the solution B by dissolving 25° C. 6.67 g of oxalic acid dihydrate in 100 ml of purified water.

On the other hand, a transparent solution was prepared by adding at 25° C. to 8.56 g of tetra-n-butyl titanate, 18.22 g of lactic acid, and by successively adding 30 g of purified water under stirring little by little. Next, to the transparent solution, 7.75 g of barium hydroxide octahydrate was added and dissolved at 25° C.; thereafter, the solution thus obtained was diluted with purified water to prepare 100 ml of a solution as the solution A.

Next, the total amount of the solution A and the total amount of the solution B were added dropwise under stirring at the same time at 25° C. to 100 ml of purified water (solution C) over a period of 15 minutes. After completion of the dropwise addition, aging was conducted at 25° C. for 15 minutes to yield a precipitate. The precipitate was filtered off and dried at 80° C. to prepare a powder.

For the powder, in the same manner as in Example 1, the electron microscope photograph was taken, and the molar ratio Ba/Ti, the BET specific surface area, the X-ray diffraction, the FT-IR spectrum and the chlorine content based on ion chromatography were measured. Consequently, the powder was revealed to be crystalline (see FIG. 4) BaTiO(C₂O₄)₂.4H₂O in terms of X-ray diffraction and to be the powder shown in Table 1. It is to be noted that the molar ratio Ba/Ti was obtained with the fluorescent X-ray method.

Further, the infrared (IR) absorption spectrum of BaTiO(C₂O₄)₂.4H₂O is shown in FIG. 5. Additionally, an electron microscope photograph is shown in FIG. 6.

### Comparative Example 2

A mixed solution was prepared as the solution A by dissolving 600 g of barium chloride dihydrate and 444 g of titanium tetrachloride in 4100 ml of water. Next, an aqueous solution of oxalic acid was prepared as the solution B by dissolving 620 g of oxalic acid dihydrate in 1500 ml of hot water at 70° C. To the solution A, the solution B was added under stirring over a period of 120 minutes while the resulting mixture was being maintained at 70° C. After completion of the addition, the mixture thus obtained was aged at 70° C. further for 1 hour under stirring. After cooling, the precipitate was collected by filtration.

Next, the collected precipitate was washed with 4.5 L of water carefully by repulping three times, and then the precipitate was filtered off and dried at 80° C. to prepare a powder.

For the powder, in the same manner as in Example 1, the optical microscope photograph was taken, and the molar ratio Ba/Ti, the BET specific surface area, the X-ray diffraction, the FT-IR spectrum and the chlorine content based on ion chromatography were measured. Consequently, the powder was revealed to be crystalline (see FIG. 7) BaTiO(C₂O₄)₂.4H₂O in terms of X-ray diffraction and to be the powder shown in Table 1. The molar ratio Ba/Ti was obtained with the fluorescent X-ray method.

Further, the infrared absorption spectrum of BaTiO(C₂O₄)₂.4H₂O is shown in FIG. 8. Additionally, an optical microscope photograph is shown in FIG. 9.

TABLE 1

| | | Comparative | Comparative |
|---|---|---|---|
| | Example 1 | Example 1 | Example 2 |
| Product | Amorphous | Crystalline | Crystalline |
| | fine | BaTiO | BaTiO |
| | particles | (C₂O₄)₂•4H₂O | (C₂O₄)₂•4H₂O |
| Molar ratio | 1.00 | 1.00 | 1.00 |
| Ba/Ti | | | |
| BET specific | 35 | 2.8 | 1.6 |
| surface area | | | |
| (m²/g) | | | |
| Average | 0.06 | 7.8 | 88 |
| particle | | | |
| size (μm) | | | |
| Chlorine | 2 | 1 | 90 |
| content | | | |
| (ppm) | | | |
| Presence or | Present | Present only | Absent |
| absence of | | in 1120 to | |
| IR spectrum | | 1140 cm⁻¹ | |
| peaks in | | | |
| 1120 to 1140 | | | |
| cm⁻¹ and in | | | |
| 1040 to 1060 | | | |
| cm⁻¹ | | | |

### Example 2

A barium titanate powder was obtained as follows: 5 g of the amorphous fine-particle powder obtained in Example 1 was calcined at 800° C. for 10 hours in the atmosphere of air, cooled, and thereafter disintegrated with a mortar to yield the barium titanate powder.

For the obtained barium titanate, the molar ratio Ba/Ti based on the fluorescent X-ray method, the average particle size, the BET specific surface area, the lattice constant ratio (C/A) based on X-ray diffraction, the presence or absence of the barium carbonate peak around 2θ=24° (see FIG. 11) and the chlorine content based on ion chromatography were measured. The physical properties of the obtained barium titanate powder are shown in Table 2. It is to be noted that the average particle size was determined as an average value over the 200 particles arbitrarily extracted at a magnification of 50 thousands. Additionally, an electron microscope photograph is shown in FIG. 10.

### Comparative Example 3

A barium titanate powder was obtained as follows: 5 g of BaTiO(C₂O₄)₂.4H₂O obtained in Comparative Example 1 was calcined at 800° C. for 10 hours in the atmosphere of air, cooled, and thereafter disintegrated with a mortar to yield the barium titanate powder.

For the obtained barium titanate, the molar ratio Ba/Ti based on the fluorescent X-ray method, the average particle size, the BET specific surface area, the lattice constant ratio (C/A) based on X-ray diffraction, the presence or absence of the barium carbonate peak around 2θ=24° (see FIG. 11) and the chlorine content based on ion chromatography were measured. The physical properties of the obtained barium titanate powder are shown in Table 2. Additionally, an electron microscope photograph is shown in FIG. 12.

### Comparative Example 4

A barium titanate powder was obtained as follows: 5 g of BaTiO(C₂O₄)₂.4H₂O obtained in Comparative Example 2 was calcined at 800° C. for 10 hours in the atmosphere of air, cooled, and thereafter disintegrated with a mortar to yield the barium titanate powder.

For the obtained barium titanate, the molar ratio Ba/Ti based on the fluorescent X-ray method, the average particle size, the BET specific surface area, the lattice constant ratio (C/A) based on X-ray diffraction, the presence or absence of the barium carbonate peak around 2θ=24° (see FIG. 11) and the chlorine content based on ion chromatography were measured. The physical properties of the obtained barium titanate powder are shown in Table 2. Additionally, an electron microscope photograph is shown in FIG. 13.

TABLE 2

| | | Comparative | Comparative |
|---|---|---|---|
| | Example 2 | Example 3 | Example 4 |
| Type of | Example 1 | Comparative | Comparative |
| calcined | | Example 1 | Example 2 |
| material | | | |
| Molar ratio | 1.00 | 1.00 | 1.00 |
| of Ba/Ti | | | |
| BET specific | 14.5 | 7.1 | 7.33 |
| surface area | | | |
| (m²/g) | | | |
| Average | 0.08 | 0.18 | 0.17 |
| particle | | | |
| size (μm) | | | |
| C/A ratio | 1.006 | 1.005 | 1.005 |
| Chlorine | 2 | 1 | 90 |
| content | | | |
| (ppm) | | | |
| Presence or | Absent | Slightly | Definite |
| absence of | | present | peak present |
| barium | | | |
| carbonate | | | |
| peak | | | |

### Example 3

A solution was prepared as the solution B by dissolving at 25° C. 6.67 g of oxalic acid dihydrate in 100 ml of ethanol.

On the other hand, a transparent solution was prepared by adding at 25° C. to 8.56 g of tetra-n-butyl titanate, 18.22 g of lactic acid, and by successively adding 30 g of purified water under stirring little by little. Successively, to the transparent solution, 7.75 g of barium hydroxide octahydrate was added and dissolved at 25° C.; thereafter, the solution thus obtained was diluted with ethanol to prepare 100 ml of a solution as the solution A. Thereafter, in the solution A, magnesium acetate was dissolved at 25° C. so as to have a content of 0.2% by weight in terms of MgO in relation to the produced barium titanate. The total amount of the solution A and the total amount of the solution B were added dropwise under stirring at the same time at 25° C. to 100 ml of ethanol (solution C) over a period of 5 minutes. After completion of the dropwise addition, aging was conducted at 25° C. for 15 minutes to yield a precipitate. The precipitate was filtered off and dried at 80° C. to prepare a powder.

For the powder, in the same manner as in Example 1, the electron microscope photograph was taken, and the molar ratio Ba/Ti, the BET specific surface area, the X-ray diffraction, the FT-IR spectrum and the chlorine content based on ion chromatography, and further the Mg content were measured. Consequently, the powder was revealed to be an amorphous fine-particle powder that was noncrystalline in terms of X-ray diffraction. It is to be noted that the molar ratio Ba/Ti was obtained with the fluorescent X-ray method and the Mg content was obtained with ICP. The physical properties of the obtained amorphous fine-particle powder are shown in Table 3.

Further, the infrared absorption spectrum of the amorphous fine-particle powder is shown in FIG. 14.

TABLE 3

| | Example 3 |
|---|---|
| Product | Amorphous fine particles |
| Molar ratio Ba/Ti | 1.01 |
| Mg content (% by weight) | 0.18 |
| BET specific surface area | 33 |
| (m²/g) | |
| Average particle size (μm) | 0.06 |
| Chlorine content (ppm) | 2 |
| Presence or absence of IR | Present |
| spectrum peaks in 1120 to | |
| 1140 cm⁻¹ and in 1040 to | |
| 1060 cm⁻¹ | |

### Example 4

A Mg-containing barium titanate powder was obtained as follows: 5 g of the amorphous fine-particle powder obtained in Example 3 was calcined at 800° C. for 10 hours in the atmosphere of air, cooled, and thereafter disintegrated with a mortar to yield the Mg-containing barium titanate powder.

For the obtained Mg-containing barium titanate, the molar ratio Ba/Ti based on the fluorescent X-ray method, the average particle size, the BET specific surface area, the lattice constant ratio (C/A) based on X-ray diffraction, the presence or absence of the barium carbonate peak around 2θ=24° (see FIG. 11) and the chlorine content based on ion chromatography were measured. Additionally, the Mg content was measured with an ICP method, and the mapping of magnesium was performed with a SEM-EDX (manufactured by JEOL corp.). The physical properties of the obtained Mg-containing barium titanate are shown in Table 4.

Additionally, as a result of the mapping analysis performed with the SEM-EDX, it was verified that Mg was dispersed uniformly.

TABLE 4

| | Example 4 |
|---|---|
| Type of calcined material | Example 3 |
| Molar ratio Ba/Ti | 1.01 |
| BET specific surface area | 18.5 |
| (m²/g) | |
| Average particle size (μm) | 0.07 |
| C/A ratio | 1.005 |
| Mg content (% by weight) | 0.18 |
| Chlorine content (ppm) | 1 |
| Presence or absence of | Absent |
| barium carbonate peak | |

### INDUSTRIAL APPLICABILITY

The amorphous fine-particle powder of the present invention can be utilized for the production of a fine perovskite-type barium titanate powder free from residual by-products such as barium carbonate and stable in quality. Additionally, the perovskite-type barium titanate powder can be utilized as the raw materials for functional ceramics such as piezoelectrics and laminated ceramic capacitors.

### BRIEF DESCRIPTION OF THE DRAWINGS

FIG. 1 is an X-ray diffraction chart of the amorphous fine-particle powder obtained in Example 1;

FIG. 2 is a chart showing the IR spectrum of the amorphous fine-particle powder obtained in Example 1;

FIG. 3 is a SEM photograph of the amorphous fine-particle powder obtained in Example 1;

FIG. 4 is an X-ray diffraction chart of the barium titanyl oxalate powder obtained in Comparative Example 1;

FIG. 5 is chart showing the IR spectrum of the barium titanyl oxalate powder obtained in Comparative Example 1;

FIG. 6 is a SEM photograph of the barium titanyl oxalate powder obtained in Comparative Example 1;

FIG. 7 is an X-ray diffraction chart of the barium titanyl oxalate powder obtained in Comparative Example 2;

FIG. 8 is chart showing the IR spectrum of the barium titanyl oxalate powder obtained in Comparative Example 2;

FIG. 9 is a SEM photograph of the barium titanyl oxalate powder obtained in Comparative Example 2;

FIG. 10 is a SEM photograph of the barium titanate powder obtained in Example 2;

FIG. 11 is an enlarged chart of the peaks due to barium carbonate around 2θ=24° in the X-ray diffraction charts of the barium titanate powders obtained in Examples 2 and 3 and Comparative Examples 3 and 4;

FIG. 12 is a SEM photograph of the barium titanate powder obtained in Comparative Example 3;

FIG. 13 is a SEM photograph of the barium titanate powder obtained in Comparative Example 4; and

FIG. 14 is a chart showing the IR spectrum of the amorphous fine-particle powder obtained in Example 3.

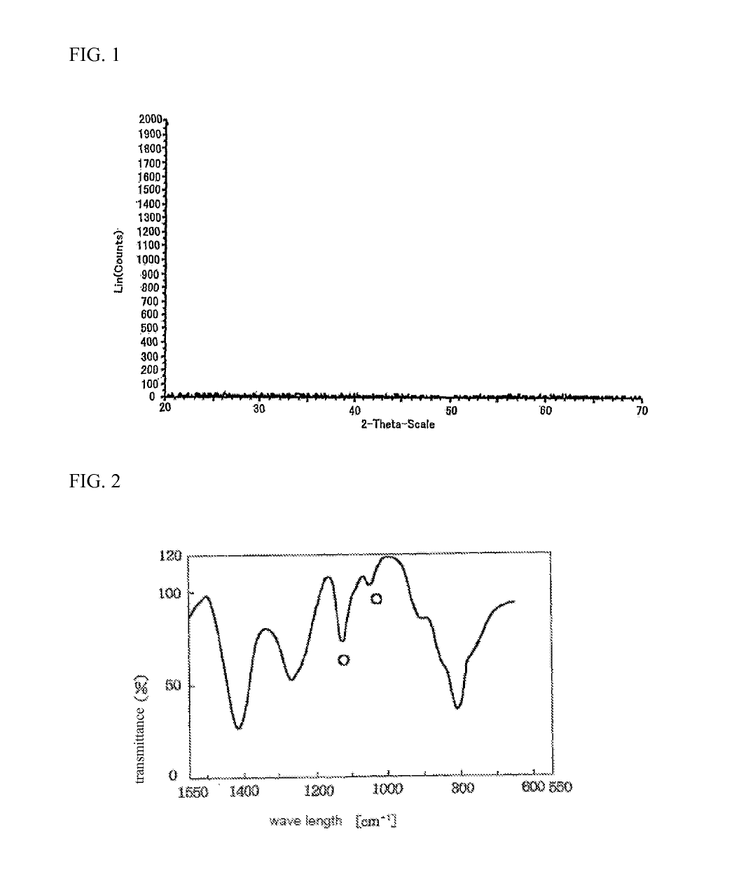

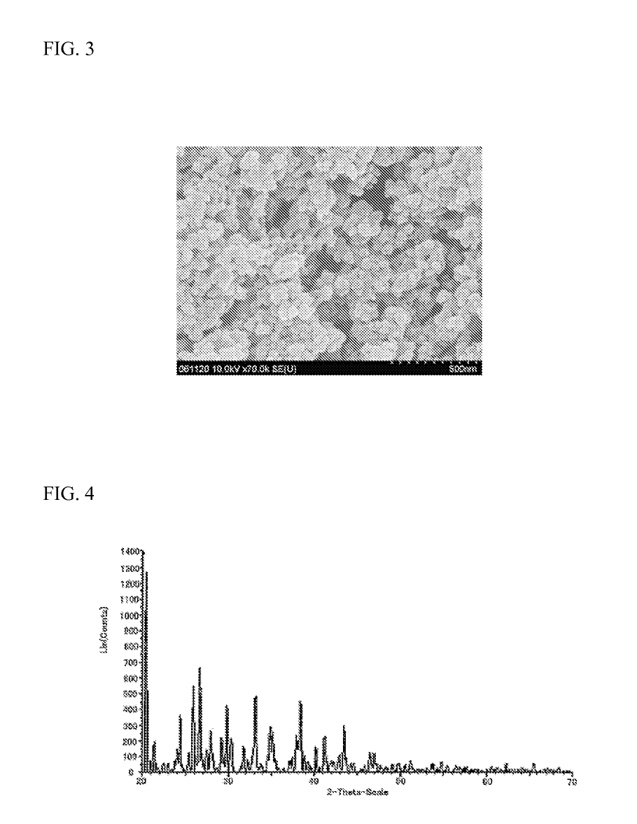

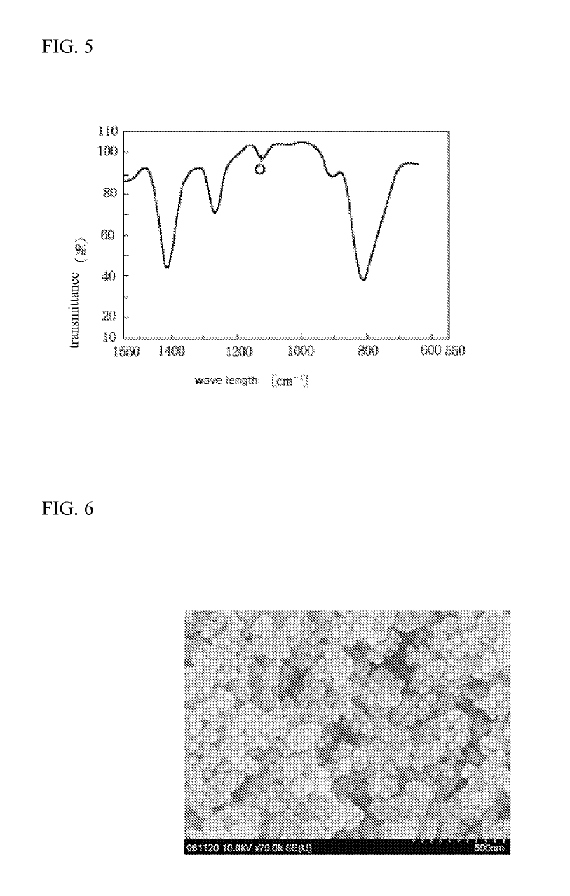

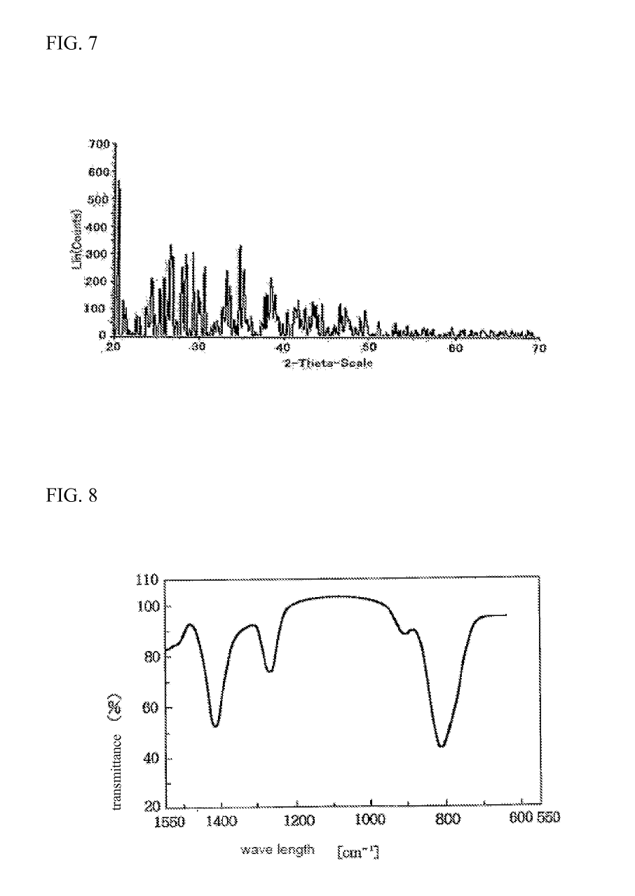

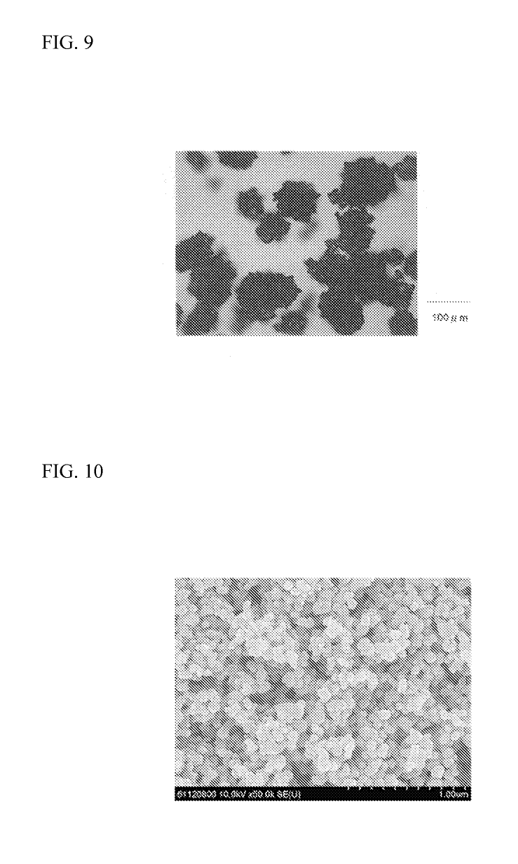

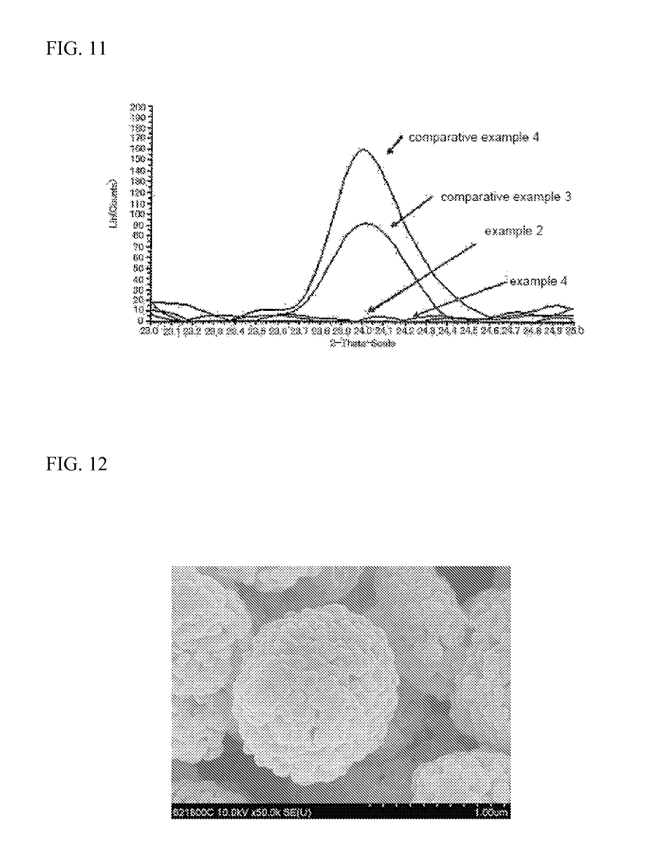

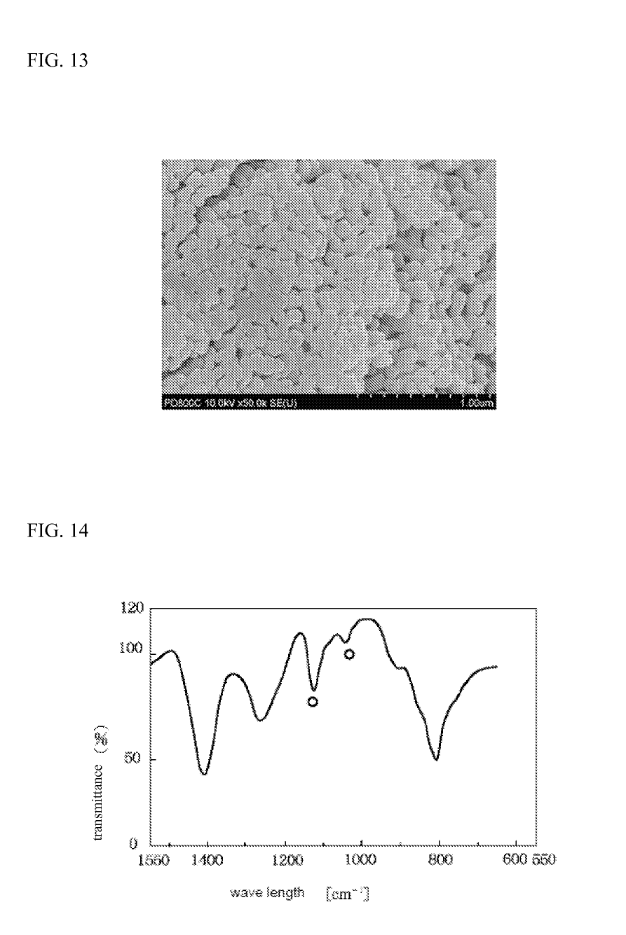

1. An amorphous fine-particle powder which is a fine-particle powder comprising titanium, barium, lactic acid and oxalic acid, characterized in that:
the average particle size thereof is 3 μm or less;
the BET specific surface area thereof is 6 m²/g or more;
the molar ratio (Ba/Ti) of Ba atoms to Ti atoms is 0.98 to 1.02;
the amorphous fine-particle powder is noncrystalline in an X-ray diffraction method; and
the amorphous fine-particle powder has a peak of an infrared absorption spectrum in each of a region from 1120 to 1140 cm⁻¹ and a region from 1040 to 1060 cm⁻¹.

2. The amorphous fine-particle powder according to claim 1, wherein the chlorine content is 70 ppm or less.

3. The amorphous fine-particle powder according to claim 1, further comprising at least one element selected from the group consisting of rare earth elements, Li, Bi, Zn, Mn, Al, Ca, Sr, Co, Ni, Cr, Fe, Mg, Zr, Hf, V, Nb, Ta, Mo, W, Sn and Si.

4. A method for producing an amorphous fine-particle powder, characterized in that a solution (solution A) that contains a titanium component, a barium component and a lactic acid component and a solution (solution B) that contains an oxalic acid component are brought into contact with each other in a solvent that contains an alcohol to be reacted with each other.

5. The method for producing an amorphous fine-particle powder according to claim 4, wherein the solution A is a solution prepared by adding a barium source to a solution that contains a titanium source, a lactic acid source and water.

6. The method for producing an amorphous fine-particle powder according to claim 5, wherein the titanium source of the solution A is a titanium alkoxide.

7. The method for producing an amorphous fine-particle powder according to claim 5, wherein the barium source of the solution A is barium hydroxide.

8. The method for producing an amorphous fine-particle powder according to claim 5, wherein the solution B is a solution that contains oxalic acid and an alcohol.

9. The method for producing an amorphous fine-particle powder according to claim 4, wherein the solution A and the solution B are added at the same time to a solution (solution C) that contains an alcohol to be brought into contact with each other.

10. The method for producing an amorphous fine-particle powder according to claim 4, wherein the solution A further comprises a compound that comprises at least one element selected from the group consisting of rare earth elements, Li, Bi, Zn, Mn, Al, Ca, Sr, Co, Ni, Cr, Fe, Mg, Zr, Hf, V, Nb, Ta, Mo, W, Sn and Si.

11. A perovskite-type barium titanate powder obtained by calcining the amorphous fine-particle powder according to claim 1.

12. The perovskite-type barium titanate powder according to claim 11, wherein the calcination temperature is 600 to 950° C.
